(19) United States
(12) Patent Application Publication
(10) Pub. No.: US 2016/0086216 A1
(43) Pub. Date: Mar. 24, 2016

(54) Facilitating the Sale of Expiring Commodities

(71) Applicant: Idea Hive, LLC, Sudbury, MA (US)

(72) Inventors: Jeff Goldberg, Sudbury, MA (US); Shri Bhupathy, Boston, MA (US)

(21) Appl. No.: 14/844,117

(22) Filed: Sep. 3, 2015

Related U.S. Application Data
(60) Provisional application No. 62/052,148, filed on Sep. 18, 2014.

(51) Int. Cl. G06Q 30/02

(52) U.S. Cl. CPC G06Q 30/0251

(57) ABSTRACT

A computer-implemented method comprising receiving, on a server, an offer for sale from a computing device related to a retailer, the offer for sale including a description of an expiring commodity and a discounted price of the expiring commodity; identifying, by the server, one or more consumers as targeted consumers by comparing the offer for sale with purchase preferences previously provided by consumers; sending, from the server, a currently unsolicited notification to a computing device related to at least one of the targeted consumers, the currently unsolicited notification including information related to the offer for sale; and receiving, on the server, from the computing device related to the targeted consumer, a purchase indication related to the expiring commodity.

### CROSS REFERENCE TO RELATED APPLICATIONS

This application claims priority to U.S. Provisional Application 62/052,148, filed on Sep. 18, 2014, the entire content of which is incorporated herein by reference.

### TECHNICAL FIELD

This invention relates to facilitating the sale expiring commodities.

### BACKGROUND

Expiring commodities diminish in value over time and can be sold for a discount from the original price.

### SUMMARY

In one aspect, a computer-implemented method includes receiving, on a server, an offer for sale from a computing device related to a retailer. The offer for sale includes a description of an expiring commodity and a discounted price of the expiring commodity. The computer-implemented method also includes identifying, by the server, one or more consumers as targeted consumers by comparing the offer for sale with purchase preferences previously provided by consumers. The computer-implemented method also includes sending, from the server, a currently unsolicited notification to a computing device related to at least one of the targeted consumers. The currently unsolicited notification includes information related to the offer for sale. The computer-implemented method also includes receiving, on the server, from the computing device related to the targeted consumer, a purchase indication related to the expiring commodity.

Implementations can include one or more of the following features.

In some implementations, at least one of the computing device related to the retailer and the computing device related to the targeted consumer is located remotely from the server.

In some implementations, the offer for sale includes a regular price of the expiring commodity.

In some implementations, each of the purchase preferences includes an expiring commodity and a value threshold.

In some implementations, comparing the offer for sale with purchase preferences of the one or more consumers includes determining whether the expiring commodity of the offer for sale matches the expiring commodity of each of the purchase preferences. Comparing the offer for sale with purchase preferences of the one or more consumers also includes determining whether the discounted price of the offer for sale satisfies the value threshold of each of the purchase preferences.

In some implementations, one or more of the purchase preferences includes a particular retailer.

In some implementations, comparing the offer for sale with purchase preferences of the one or more consumers includes determining whether the retailer associated with the offer for sale matches the particular retailer of the one or more purchase preferences.

In some implementations, the currently unsolicited notification includes one or more of a name of the retailer, an address of the retailer, the description of the expiring commodity, the discounted price of the expiring commodity, a regular price of the expiring commodity, and a quantity field.

In some implementations, the currently unsolicited notification includes a purchase code related to a consumer preference.

In some implementations, the currently unsolicited notification includes a countdown timer that represents a time limit for the targeted customer to send the purchase indication.

In some implementations, the countdown timer can be temporarily frozen one or more times.

In some implementations, a credit is provided in order to temporarily freeze the countdown timer.

In some implementations, the purchase indication is provided by a message from the targeted consumer.

In some implementations, the computer-implemented method also includes updating the discounted price of the expiring commodity.

In some implementations, the discounted price of the expiring commodity is updated based on an expiration date of the expiring commodity.

In some implementations, the expiring commodity is edible.

In some implementations, the expiring commodity is a material item.

In some implementations, the expiring commodity is a piece of clothing, an electronic item, or a vehicle.

In some implementations, the expiring commodity is a non-edible, non-material item.

In some implementations, the expiring commodity is a virtual commodity.

In some implementations, the virtual commodity is software.

In some implementations, the expiring commodity is a location that provides lodging.

In some implementations, the location that provides lodging is a hotel room.

In some implementations, the expiring commodity is a ticket.

In some implementations, the ticket is a travel ticket.

In some implementations, the travel ticket is an airline ticket, a train ticket, a ferry ticket, or a bus ticket.

In some implementations, the ticket is an entertainment event ticket.

In some implementations, the entertainment event ticket is a theater ticket, a concert ticket, a sporting even ticket, or a movie ticket.

In some implementations, the expiring commodity is a reservation for food consumption or entertainment.

In some implementations, the reservation is a dining reservation.

In some implementations, the currently unsolicited notification is a push notification.

In some implementations, at least one of the computing device related to the retailer and the computing device related to the targeted consumer is a smartphone.

In some implementations, the currently unsolicited notification is only sent to computing devices related to targeted consumers who are specified in the offer for sale.

In some implementations, the currently unsolicited notification is only sent to computing devices related to targeted consumers whose purchase preferences have identified the retailer as an approved retailer.

In some implementations, the currently unsolicited notification is not sent to computing devices related to targeted consumers whose purchase preferences have identified the retailer as a blocked retailer.

In some implementations, the computer-implemented method also includes receiving, on the server, from the computing device related to the retailer, information related to one or more expiring commodities that the retailer has previously sold, has in-stock, or intends to purchase.

In some implementations, the computer-implemented method also includes receiving, on the server, from the computing device related to the retailer, information related to past, existing, or prospective customers of the retailer.

In another aspect, a system includes a server that includes a memory configured to store instructions. The server also includes a processor to execute the instructions to perform a method. The method includes receiving, on the server, an offer for sale from a computing device related to a retailer. The offer for sale includes a description of an expiring commodity and a discounted price of the expiring commodity. The method also includes identifying, by the server, one or more consumers as targeted consumers by comparing the offer for sale with purchase preferences previously provided by consumers. The method also includes sending, from the server, a currently unsolicited notification to a computing device related to at least one of the targeted consumers. The currently unsolicited notification includes information related to the offer for sale. The method also includes receiving, on the server, from the computing device related to the targeted consumer, a purchase indication related to the expiring commodity.

Implementations can include one or more of the following features.

In some implementations, the system also includes a matching engine that resides on the server. The matching engine is configured to determine whether the expiring commodity of the offer for sale matches the expiring commodity of each of the purchase preferences. The matching engine is also configured to determine whether the discounted price of the offer for sale satisfies the value threshold of each of the purchase preferences.

In some implementations, the system also includes a pricing engine that resides on the server. The pricing engine is configured to update the discounted price of the expiring commodity.

In some implementations, the pricing engine considers data related to one or more of foreign exchange market trends, financial market trends, economic trends, news and events, regional and sub-regional trends, global trends, commodity pricing, commodity quality, nature dependent analysis, specific sales by business, calendar based holidays/events, religious trends, cultural trends, commodity demand, inventory, custom business-specified validation, custom business-specified rules, commodity pricing history, commodity purchase history, and sentiment analysis.

In some implementations, the system also includes multiple instances of the pricing engine. The multiple instances of the pricing engine are configured to communicate with each other and share information.

In some implementations, no two instances of the pricing engine consider an exact same set of data.

In some implementations, the discounted price of the expiring commodity is updated based on an expiration date of the expiring commodity.

In another aspect, a computer program product tangibly embodied in an information carrier includes instructions that when executed by a processor perform a method including receiving, on a server, an offer for sale from a computing device related to a retailer. The offer for sale includes a description of an expiring commodity and a discounted price of the expiring commodity. The method also includes identifying, by the server, one or more consumers as targeted consumers by comparing the offer for sale with purchase preferences previously provided by consumers. The method also includes sending, from the server, a currently unsolicited notification to a computing device related to at least one of the targeted consumers. The currently unsolicited notification includes information related to the offer for sale. The method also includes receiving, on the server, from the computing device related to the targeted consumer, a purchase indication related to the expiring commodity.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a system for facilitating a sale of expiring commodities.

FIG. 2 is an example of an interface used by a consumer to define a purchase preference.

FIG. 3 is a flow chart outlining a process for a consumer to purchase an expiring commodity.

FIG. 4 is a flow chart outlining a process for a retailer to specify an offer for sale for an expiring commodity that is sent to a consumer as a push notification.

FIG. 5 is a block diagram of the Pricing Engine of FIG. 4.

FIG. 6 is a flowchart of a process for purchasing an expiring commodity.

FIG. 7 is a block diagram of a computer system and associated components.

### DETAILED DESCRIPTION

An expiring commodity is a commodity that diminishes in value over time or is no longer sellable or useful after a particular time. As one example, the value of food at a grocery store diminishes in value over time as the food becomes less fresh. The food is also no longer sellable or useful after a particular time (e.g., the expiration date of the food). The food may be offered for sale initially at a particular price. However, as the expiration date of the food approaches, the grocery store may choose to lower the price to motivate a consumer to purchase the food before the expiration date, or else take the risk of the food spoiling.

Some consumers may be willing to purchase the fresh food at the initial price. However, other consumers may not be able to afford the initial price or may instead prefer to wait for the food to be discounted. Some consumers may want to purchase the food, but only if the price of the food is below a particular threshold.

Typically, retailers who are in the business of selling expiring commodities rely on in-store advertisements, flyers, or emails to announce discounts. However, a consumer who would be willing to purchase the expiring commodity may not become aware of the discount until it is too late (e.g., until after the commodity has expired). Additionally, the consumer may only be interested in particular products, which may or may not be in any advertised media and will require a great deal of time to discover such deals, quantities, or availability.

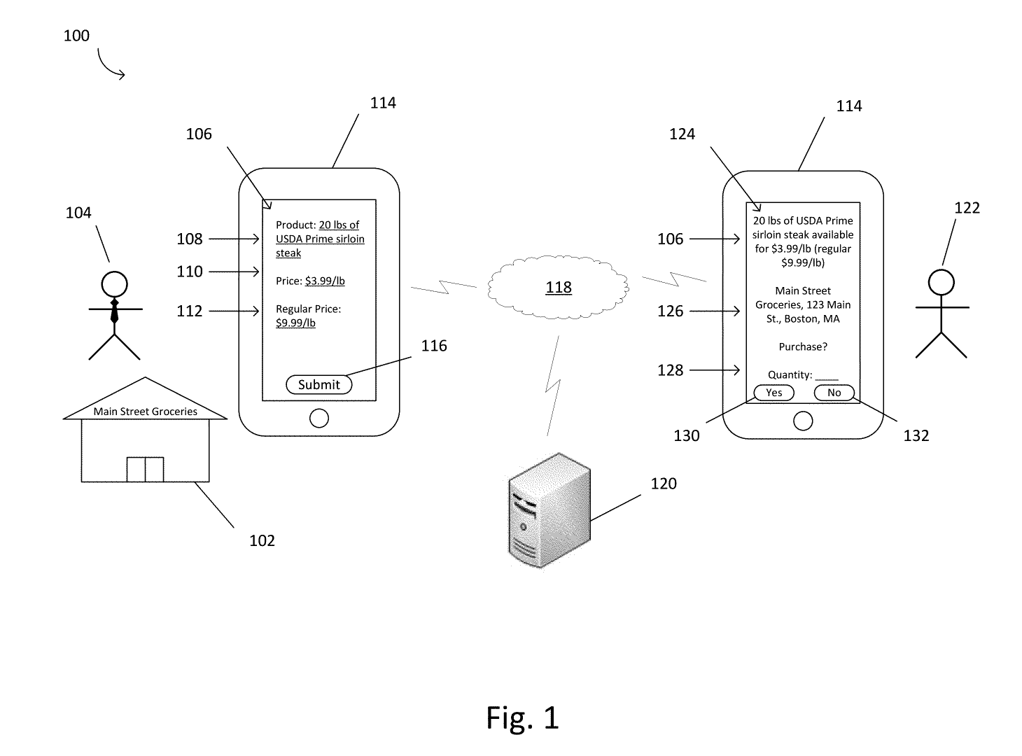

FIG. 1 shows a system 100 for facilitating a sale of expiring commodities by sending a currently unsolicited offer for sale to targeted consumers using push technology. Main Street Groceries is a retailer 102 that sells expiring commodities (e.g., food). One example of a food that the retailer 102 sells is USDA prime sirloin steak. The retailer 102 may receive a large shipment of fresh steak from a supplier on July 1^{st}. The fresh steak is initially priced at $9.99 per pound. Between July 1^{st} and July 3^{rd}, the retailer 102 may sell a majority of the fresh steak as customers stock up for holiday cookouts. However, come July 4^{th}, there are still 20 pounds of steak remaining. The expiration date of the steak is approaching, and the retailer 102 might not expect there to be a high demand for steak in the coming days.

An employee 104 of the retailer 102 is in charge of determining selling prices for food. The employee 104 wants to recover at least a portion of the cost of the steak before it goes bad. The employee 104 creates an offer for sale 106 that includes a description and quantity of the commodity 108 and the discounted price of the commodity 110. The offer for sale 106 may also include the regular price of the commodity 112. In this example, the offer for sale 106 is for USDA Prime sirloin steak, the quantity of the commodity 108 is 20 pounds, and the price of the commodity 110 is $3.99 per pound. The employee 104 defines the offer for sale 106 using a computing device 114. In some examples, the computing device 114 is a mobile computing device such as a cellular telephone or a smartphone.

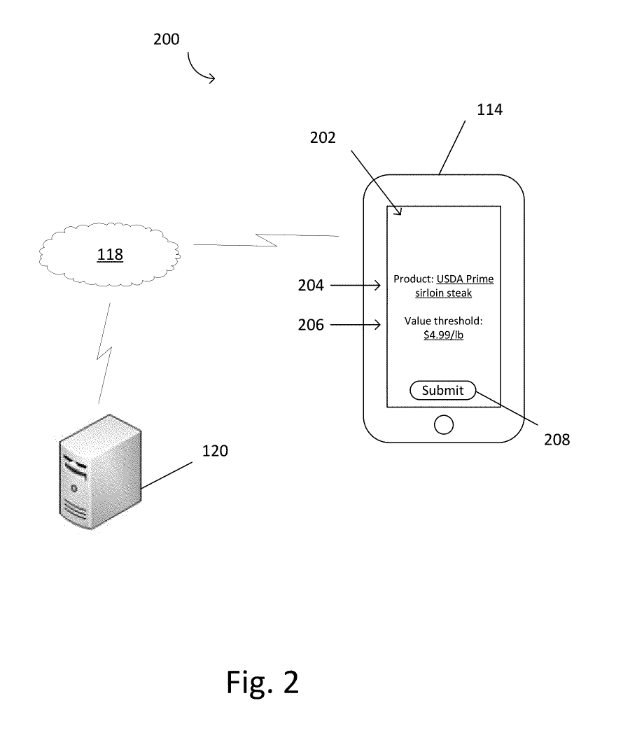

The computing device 114 includes a transceiver that allows the computing device 114 to communicate wirelessly with a network 118. A server 120 is also in wireless communication with the network 118. The employee 104 transmits the offer for sale 106 to the server 120 via the network 118 by selecting a “submit” button 116 on a display of the computing device 114. The server 120 receives and processes the offer for sale 106. The server 120 then sends information related to the offer for sale 106 to one or more targeted consumers (e.g., the targeted consumer 122) via the network 118 using push technology. The targeted consumers are determined according to purchase preferences 202 (shown in FIG. 2) that are predefined by consumers, as described in more detail below.

The targeted consumer 122 receives a push notification 124 on his computing device 114 from the server 120 via the network 118. The push notification 124 is initiated by the server 120 and in some cases is sent shortly after the offer for sale 106 is processed by the server 120. The push notification 124 is a currently unsolicited notification. That is, the transmission of the push notification 124 is not initiated by a timely request by the targeted consumer 122. Rather, the push notification 124 is initiated by the server 120 based on the previously-defined purchase preferences 202. The push notification 124 includes information related to the offer for sale 106. In some examples, the push notification 124 can include information related to the commodity, information related to the retailer, and information related to an available or desired quantity of the commodity to assist the targeted consumer 122 in deciding whether to make a purchase. The push notification 124 can also provide various options for the targeted consumer 122 to react to the push notification 124. For example, the push notification 124 can include the name and address 126 of the retailer 102 that submitted the offer for sale 106, a description of the commodity, a price of the commodity, a quantity field 128 for entering in a desired quantity for purchase, a “yes” selection button 130, and a “no” selection button 132. If the targeted consumer 122 wants to purchase the steak, the targeted consumer 122 can send a purchase indication. The targeted consumer 122 can enter a desired quantity in the quantity field 128 and select the “yes” selection button 130. If the targeted consumer 122 does not want to purchase the steak, the targeted consumer 122 can either select the “no” selection button 132 or do nothing.

FIG. 2 shows an example of an interface 200 used by a consumer to define a purchase preference 202. A purchase preference 202 is a set of criteria defined by the consumer that can be used to determine offers for sale that the consumer may be interested in. The purchase preference 202 includes a commodity 204 and a value threshold 206. In some examples, the purchase preference 202 also includes a particular retailer. The consumer can manually enter the commodity 204 and the value threshold 206 into the computing device 114. Alternatively, the consumer can select the commodity 204 from a list of commodities. The consumer can also access a website of a particular retailer and select the commodity 204 from the website.

In this example, the consumer has defined a purchase preference 202 for USDA Prime sirloin steak at a value threshold of $4.99 per pound. That is, the consumer has indicated that he is interested in an offer for sale of USDA Prime sirloin steak if the price is $4.99 per pound or less. In this example, because the purchase preference 202 does not include a particular retailer, the consumer has indicated that he is interested in an offer for sale from any retailer that meets his purchase preference 202 criteria. The consumer transmits the purchase preference 202 to the server 120 via the network 118 by selecting a “submit” button 208 on the display of the computing device 114. Referring back to FIG. 1, the targeted consumer 122 who received the push notification 124 may have previously submitted the purchase preference 202 of FIG. 2.

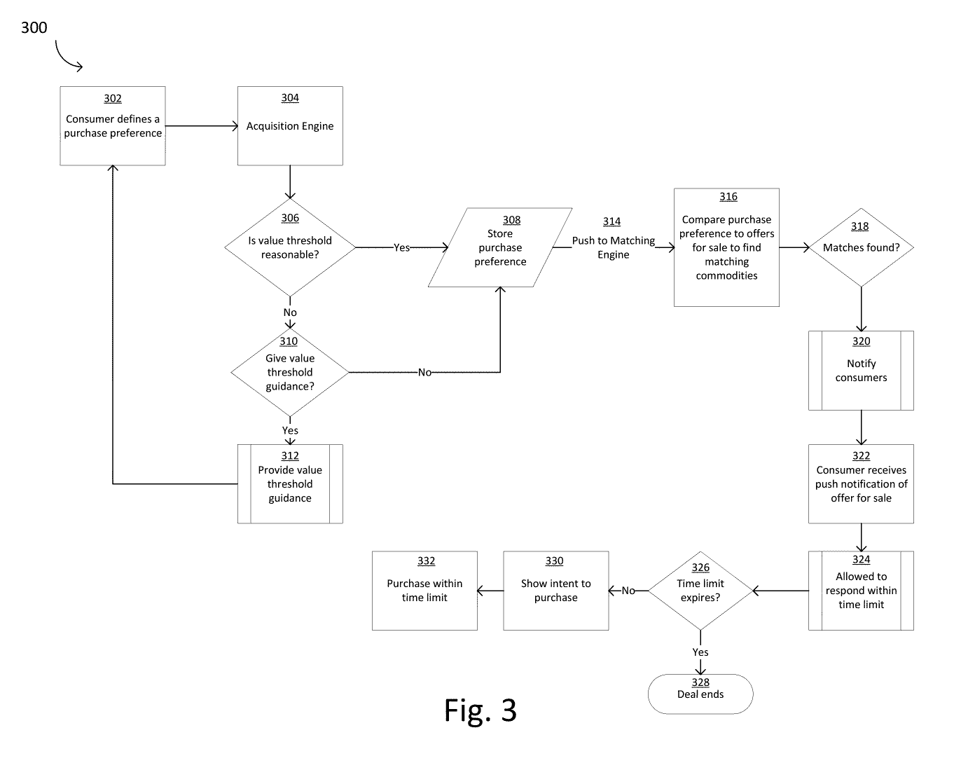

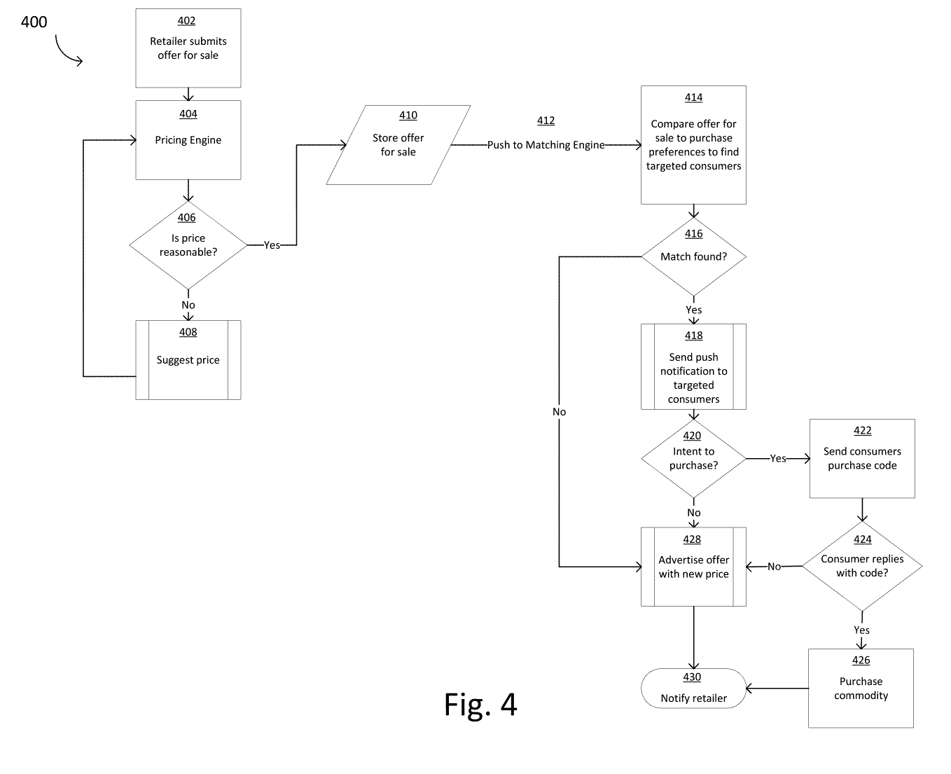

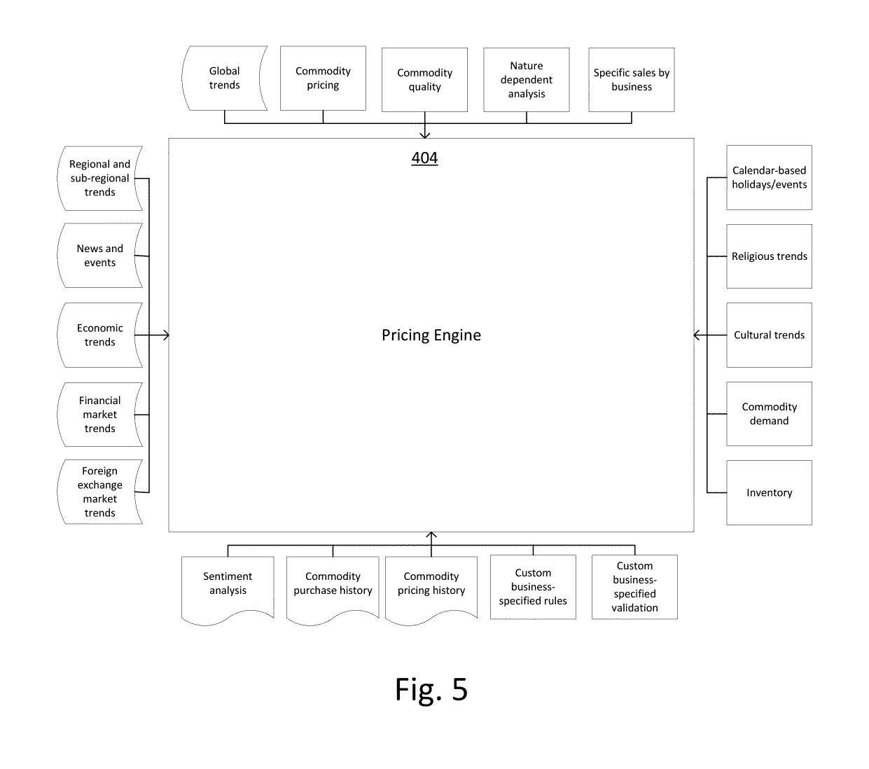

FIG. 3 shows a flow chart 300 outlining a process for a consumer to purchase an expiring commodity through an offer for sale that is sent to the consumer using push technology. A consumer defines a purchase preference 302, e.g., using the interface 200 shown in FIG. 2. The purchase preference includes a commodity and a value threshold. The purchase preference is sent to an Acquisition Engine 304. The Acquisition Engine 304 resides on the server 120 (shown in FIGS. 1 and 2). The Acquisition Engine 304 considers data from a number of sources to determine whether the value threshold for the particular commodity is reasonable 306 in a similar manner as described below with reference to the Pricing Engine 404 (shown in FIGS. 4 and 5). If the Acquisition Engine 304 determines that the value threshold for the commodity is reasonable, the purchase preference is stored 308 on the server 120. If the Acquisition Engine 304 determines that the value threshold for the commodity is not reasonable, the Acquisition Engine 304 offers to provide the consumer with guidance 310. If the consumer chooses to accept the guidance, the Acquisition Engine 304 provides value threshold guidance 312. For example, the Acquisition Engine 304 may suggest an appropriate value threshold for the particular commodity based on statistical sales data. The consumer can then restart the process and identify a purchase preference 302 using the suggested value threshold. If the consumer chooses not to accept the guidance, the purchase preference is stored 308 on the server 120.

In some implementations, information related to commodities in the purchase preference is stored. The information that can be stored can include commodity attributes (e.g., clothing sizes). The information that can be stored can also include purchase trends related to commodities. For example, the process may recognize that the consumer has purchased a particular commodity at particular times (e.g., the consumer has purchased flowers on Valentine's Day the past three years). This stored information can be accessed when the consumer defines future purchase preferences.

In some implementations, the purchase preference includes an option for the consumer to enable automatic purchase of a commodity in an offer for sale that matches the criteria of the purchase preference. The automatic purchase option can include a feature that allows the consumer to set a date and time range indicating when the automatic purchase option is to be enabled. Automatic purchase is defined as a purchase that does not require a confirmation from the consumer prior to effectuating the purchase. After the purchase preference is stored 308, the purchase preference is pushed to the Matching Engine 314. The Matching Engine compares 316 the purchase preference to offers for sale from retailers (e.g., the offer for sale 106 from the retailer 102 of FIG. 1) to find matching commodities. That is, the Matching Engine identifies commodities included in offers for sale that fit the criteria of the purchase preference defined by the consumer, namely, the particular commodity and the value threshold.

If matches are found 318 by the Matching Engine, the consumer is notified 320. The consumer receives a push notification 322 of the offer for sale that matches the consumer's purchase preferences. In some implementations, the consumer receives multiple push notifications 322, each of which identifies an offer for sale that matches the consumer's purchase preferences. A consumer who receives a push notification of an offer for sale that matches the consumer's purchase preference is referred to as a targeted consumer (e.g., targeted consumer 122 of FIG. 1). The push notification can be sent in a variety of forms, e.g., as an instant message, a text message, an email, or some other electronic communication medium. The push notification can also be sent to a website, and the consumer can access the push notification by accessing the website.

The push notification (e.g., the push notification 124 of FIG. 1) includes information related to the matching offer for sale. The push notification can include the name and address of the retailer that submitted the matching offer for sale, a description of the commodity, a price of the commodity, a quantity field for entering in a desired quantity for purchase, a “yes” selection button, and a “no” selection button. In some implementations, a further authorization and/or authentication of the consumer and the intent to complete the purchase may be used (e.g., an alphanumeric code request to be replied to the server 120, fingerprint identification, facial recognition, etc.).

In some implementations, the push notification includes a countdown timer that represents a time limit for the consumer to respond 324 to the push notification. The consumer can purchase the commodity 332 included in the offer for sale up until the time limit expires 326. To purchase the commodity 332, the consumer enters a desired quantity in the quantity field and selects the “yes” selection button. In some implementations, changing the quantity changes the price of the commodity. If the time limit expires 326, the deal ends 328 and the offer for sale can no longer be accepted by the consumer. In some implementations, such as when the push notification is sent as an email, the consumer can purchase the commodity 332 by responding to the email. In some implementations, such as when the push notification is sent to a website, the consumer can purchase the commodity 332 by interacting with the website.

In some implementations, such as when the consumer enables automatic purchase of a commodity in an offer for sale that matches the criteria of the defined purchase preference, the commodity is automatically purchased when the consumer receives the push notification. In such cases, the consumer does not need to interact with the push notification in order to purchase the commodity. When automatic purchase is enabled, the countdown timer can be disabled.

In some implementations, if the consumer shows intent to purchase 330 before the time limit expires 326, the offer for sale may be left open beyond the expiration of the time limit. For example, the consumer may indicate that he intends to purchase 330 the commodity, but he may not have finalized the purchase. In such a case, the offer for sale is left open for an additional length of time to give the consumer the opportunity to finalize the purchase.

In some implementations, the countdown timer is not started until the consumer shows intent to purchase 330. In such a case, the offer for sale is locked for acceptance by the consumer for the duration of the countdown timer. In other words, for the duration of the countdown timer, the consumer is guaranteed the opportunity to accept the offer for sale without the risk of the offered commodity being sold to somebody else.

In some implementations, the push notification includes a snooze feature that the consumer can utilize to extend the time limit or temporarily freeze the countdown timer. For example, if the consumer needs more time to decide whether he wants to purchase the commodity, he can select a “snooze” button that is included in the push notification. The “snooze” button can be accompanied by a user-definable field that represents the length of time of the snooze. The timer and snooze functions can be specified by the retailer in the retailer's preferences, as described in more detail below.

In some implementations, the consumer can utilize the snooze feature multiple times to repeatedly freeze the countdown timer. The consumer provides a credit in order to temporarily freeze the countdown timer. The credit may be in the form of currency or award points accumulated by performing specific applications within the ecosystem.

In some implementations, rather than purchasing the commodity 332, the consumer can respond to the push notification with a counteroffer, which the retailer can either decline or accept. In some implementations, the consumer can define new purchase preferences when responding to the push notification. In some implementations, the consumer and the retailer can engage in a negotiation for a purchase price (e.g., via video, audio, email, text message, instant message, etc.).

In some implementations, the push notification includes an option to save the offer for sale for later (e.g., for a later acceptance). Rather than purchasing the commodity 332 immediately, the consumer can elect to save the offer for sale for later. The consumer can then purchase the commodity 332 at a later time.

In some implementations, the consumer can forward the offer for sale to other people. The ability to forward the offer for sale may be limited based on the quantity of the commodity related to the offer for sale that is available. In some implementations, such as when a commodity is sold as a set (e.g., in the context of tickets to an event), the consumer can purchase less than all of the quantity of the commodity and forward the remaining quantity to other people. In some implementations, the retailer can limit the ability of the offer for sale to be forwarded. In some implementations, a notification related to the forwarded offer for sale includes a countdown timer. The countdown timer can have a longer time limit, a shorter time limit, or the same time limit as the original offer for sale.

In some implementations, the consumer can post information related to the purchase to a website, such as a social medial website. In the case where there is a remaining quantity of the commodity available, the offer for sale itself can be posted to the website for acceptance by other potential consumers. The posted offer for sale can also include a countdown timer.

In some implementations, the consumer receives credit for posting or forwarding an offer for sale or for posting information related to a purchase. The credit may be in the form of currency or award points that can be used to make future purchases. In some implementations, the credit can be used to utilize the snooze feature to freeze the countdown timer.

In some implementations, the push notification includes comparable pricing of the commodity from other sources. For example, the push notification can include the price of the commodity from various stores. The push notification can also include links to those stores. The consumer can interact with the links to view additional information related to the commodity.

In some implementations, the purchase preference includes one or more consumer preferences that define additional information related to the criteria. For example, the consumer preferences can include a consumer-defined list of approved retailers from whom the consumer wants to receive push notifications that include information related to offers for sale. Similarly, the consumer preferences can include a consumer-defined list of blocked retailers from whom the consumer does not want to receive any push notifications. In some implementations, the consumer can specify one or more specific persons (e.g., a particular sales representative) from a particular retailer from whom the consumer does not want to receive any push notifications. In some implementations, the consumer can define time and/or quantity limits on push notifications received from the one or more specific persons.

In some implementations, the consumer preferences can include a consumer-defined list of one or more specific persons (e.g., a particular sale representative) from a particular retailer from whom the consumer wants to receive all push notification. Such a feature may require specific authorization from the consumer to allow the one or more specific persons to send unconditional push notifications. Push notifications originating from the one or more specific persons bypass the Matching Engine and are sent to the consumer without taking into account the consumer's purchase preference and the offer for sale. For example, a consumer may be a frequent shopper at a particular retail store. A sales person at the particular retail store may consistently hold certain items for the consumer that are suited for the consumer (e.g., clothing of a particular size and/or style). In the consumer preferences, the consumer may specifically authorize the sales person to send push notifications to the consumer without any limitations, thereby bypassing the Matching Engine. In some implementations, the consumer can define certain items that the sales person is authorized to send push notifications related to. In some implementations, one or more limitations can be imposed on the sales person's ability to send push notifications to the consumer. For example, the consumer may specify a specific window of time during which the sales person can send push notifications.

While we described a single consumer defining a single purchase preference 302 and the single consumer being identified by the Matching Engine, it should be understood that many consumers define one or more purchase preference 302. The Matching Engine compares 316 purchase preferences from multiple consumers to offers for sale from retailers, and all consumers who have matching purchase preferences are identified as targeted consumers. The targeted consumers then receive push notifications 322.

FIG. 4 shows a flow chart 400 outlining a process for a retailer to specify an offer for sale for an expiring commodity that is sent to a consumer using push technology. Some portions of the flow chart 400 are similar to portions of the flow chart 300 of FIG. 3, although this flow chart 400 is from the retailer's perspective.

A retailer creates and submits an offer for sale 402. The offer for sale (e.g., the offer for sale 106 of FIG. 1) can be defined using the computing device 114. The offer for sale includes a description and quantity of a commodity and a discounted price of the commodity. The offer for sale can also include the regular price of the commodity. An employee of the retailer can manually enter the information related to the offer for sale into the computing device 114.

The offer for sale can also include retailer preferences. In some implementations, the retailer preferences include information related to the lifespan of the offer for sale. For example, the retailer can specify a time limit that represents the amount of time a consumer has to accept the offer for sale before it expires. The retailer can also specify whether the offer for sale includes a snooze feature, as described above. The retailer can define parameters of the snooze feature, such as maximum allowable snoozes and durations.

The offer for sale is sent to a Pricing Engine 404. The Pricing Engine 404 resides on the server 120 (shown in FIGS. 1 and 2). The Pricing Engine 404 considers data from a number of sources to determine whether the discounted price of the commodity is reasonable 406, as described in more detail below. If the discounted price is not reasonable, the Pricing Engine 404 suggests a price 408 based on the same data. In some implementations, the suggested price can be either accepted or rejected by the retailer. If the suggested price is accepted, the price is updated. In some implementations, the Pricing Engine 404 automatically updates the price without requiring further input from the retailer, as determined by the retailer preferences.

If participating in the workflow, the Pricing Engine 404 determines that the price is reasonable, the offer for sale is stored 410 on the server 120. The offer for sale is then pushed to the Matching Engine 412. The Matching Engine compares 414 the offer for sale to purchase preferences to find targeted consumers. That is, the Matching Engine identifies one or more consumers who have submitted a purchase preference that includes criteria that the offer for sale fits. In particular, the Matching Engine determines whether the particular commodity and the value threshold included in a purchase preference fits the description, quantity, and discounted price included in the offer for sale.

If a match is found 416 by the Matching Engine, a push notification is sent to one or more of the targeted consumers 418. The push notification (e.g., the push notification 124 of FIG. 1) includes information related to the offer for sale that matches the consumer's purchase preference. The push notification can include the name and address of the retailer that submitted the offer for sale, a description of the commodity, a quantity field for entering in a desired quantity for purchase, a “yes” selection button, and a “no” selection button.

In some implementations, the retailer can cause the Matching Engine to only identify certain consumers as targeted consumers. For example, the retailer can specify certain consumers in the retailer preferences who are available to the Matching Engine when identifying consumers as targeted consumers. As such, only the specified consumers receive a push notification that includes information related to the offer for sale. For example, if a consumer is in a specific group of consumers who purchase a high volume from a retailer, the consumer may be included in a subset of consumers who the retailer may direct unique offers and special sales to. Such unique offers and special sales are not available to consumers who are included in the subset.

If a targeted consumer indicates intent to purchase 420 the commodity, a purchase code is sent to the targeted consumer 422. If the targeted consumer replies to the push notification with the purchase code 424, the targeted consumer purchases the commodity 426. For example, the targeted consumer may enter the purchase code into a field included in the push notification. In some implementations, the targeted consumer may enter a desired quantity in the quantity field of the push notification and select the “yes” selection button to finalize the purchase of the commodity.

In some implementations, a credit card associated with the targeted consumer is charged when the targeted consumer purchases the commodity 426. The targeted consumer's credit card information can be previously entered and stored on the server 120 such that the targeted consumer does not have to enter his credit card information at the time of purchase. In some implementations, the targeted consumer can manually enter his credit card information when he purchases the commodity 426. In some implementations, the credit card or banking information may be stored on the targeted consumer's computing device (e.g., the computing device 114 of FIGS. 1 and 2). In some implementations, the computing device is an iPhone™ that utilizes Apple Pay™, and the targeted consumer can use the stored payment information to pay for the commodity. In some implementation, the credit card associated with the targeted consumer is charged via a communication with an external system associated with the customer (e.g., a bank account, a credit card account, etc.).

In some implementations, the Matching Engine is unable to find any targeted (e.g., matching) consumers. Alternatively, the Matching Engine may have found targeted consumers, but none of the targeted consumers indicated intent to purchase the commodity or responded to the push notification with the purchase code. In such cases, the offer for sale can be advertised with a new price 428. For example, the offer for sale can be advertised with a new price 428 on a website or a computing device. A computing device application (e.g., such as a smartphone application) can be associated with the process outlined by the flowcharts 300 and 400 of FIGS. 3 and 4, respectively. The new price is typically less than the regular price of the commodity, but greater than the discounted price of the commodity that was offered to the targeted consumers. When the offer for sale is advertised with a new price 428, the retailer is notified 430 so that the retailer can adjust the price of the commodity accordingly.

The retailer is also notified 430 when a targeted consumer purchases the commodity. The retailer and the targeted consumer can then effectuate the purchase in a number of ways. For example, the targeted consumer can pick up the purchased commodity at one of the retailer's stores. In some implementations, the consumer is associated with an identification code, and the consumer must present the identification code at the retailer's store in order to pick up the purchased commodity. Alternatively, the retailer can ship the purchased commodity to the targeted consumer. After a purchase occurs, the retailer can write a review for the targeted consumer and the target consumer can write a review for the retailer. The review can be submitted to the server 120, and information related to the review can be accessed by other consumers and retailers.

In some implementations, before, during, or after a retailer specifies an offer for sale for an expiring commodity, the retailer is presented with information from a dashboard provided through an application associated with the process outlined by the flow chart 400. The dashboard can include information related to purchasing trends of consumers. The dashboard can assist the retailer in determining a particular commodity to sell, a price for which to sell the particular commodity, and an optimal time at which to sell the particular commodity. In some implementations, the process outlined by the flow chart 400 causes the dashboard to notify the retailer when an optimal sale opportunity arises.

While we described a single retailer submitting a single offer for sale 402, it should be understood that many retailers submit one or more offers for sale 402. The Matching Engine may compare 414 purchase preferences from multiple consumers to offers for sale from multiple retailers.

The Matching Engine of FIGS. 3 and 4 may not immediately find a match between a purchase preference and an offer for sale. The Matching Engine, which resides on the server 120 (shown in FIG. 1), continuously monitors purchase preferences defined by consumers and offers for sale submitted by retailers in an attempt to identify matches. For example, a consumer may define a purchase preference that includes criteria that do not match any offers for sale stored on the server 120. Accordingly, upon defining the purchase preference, the consumer would not receive a push notification. At a later time, a retailer may submit an offer for sale that matches the criteria of the purchase preference. When the offer for sale is submitted, the Matching Engine identifies a match between the offer for sale and the purchase preference. The consumer (who is now a targeted consumer) would receive a push notification shortly after the offer for sale is submitted. In this way, the push notification substantially instantaneously notifies the targeted consumer of the offer for sale of interest.

FIG. 5 shows a block diagram of the Pricing Engine 404 of FIG. 4. As described above, the Pricing Engine 404 resides on the server 120 and can consider data from one or more of a number of sources to determine whether the discounted price of the commodity included in the offer for sale is reasonable. If the Pricing Engine 404 determines that the discounted price of the commodity is not reasonable, the Pricing Engine 404 updates the price in the offer for sale based on the data from the various sources.

The Pricing Engine 404 can include one or more subcomponents. Each subcomponent can consider data related to one or more of foreign exchange market trends, financial market trends, economic trends, news and events, regional and sub-regional trends, global trends, commodity pricing, commodity quality, nature dependent analysis, specific sales by business, calendar based holidays/events, religious trends, cultural trends, commodity demand, inventory, custom business-specified validation, custom business-specified rules, commodity pricing history, commodity purchase history, and sentiment analysis. In some implementations, each subcomponent of the Pricing Engine 404 considers data related to each of the items listed above.

In some implementations, the Pricing Engine 404 includes one, multiple, or no instances of each component. In some implementations, multiple instances of the Pricing Engine 404 reside on the server 120. In some implementations, the multiple instances of the Pricing Engine 404 can have entirely discrete tasks. Each tasks can be related to the items that correspond to the subcomponents of the Pricing Engine 404. In some implementations, the multiple instances of the Pricing Engine 404 can same one or more similar tasks. For example, two instances of the Pricing Engine 404 may consider the exact same set of data related to the subcomponents of the Pricing Engine 404. That is, each instance of the Pricing Engine 404 may consider data related to each and every one of the items related to the subcomponents listed above. Alternatively, in some examples, one instance of the Pricing Engine 404 may consider data related to a subset of the items related to the subcomponents listed above, and another instance of the Pricing Engine 404 may consider data related to a different subset of the items related to the subcomponents. In some examples, multiple instances of the Pricing Engine 404 may consider non-identical sets of data, while considering some common data. In some implementations, the multiple instances of the Pricing Engine 404 are configured to communicate with each other and share information. In some implementations, the Pricing Engine 404 considers information different than the items listed above.

Regarding foreign exchange market trends, exchange rates fluctuate regularly and can affect purchase values between a time when the retailer purchased the commodity and a time when the retailer sells the commodity to a consumer. The change in value of the commodity assists the Pricing Engine 404 in determining an appropriate price for the commodity.

Regarding financial market trends, public perception of future income can affect daily purchase habits and behaviors of consumers. For example, if the stock market is relatively low, the average consumer is likely hurt financially and is looking harder than ever for discounts. Thus, financial market trends can indirectly influence what a consumer is willing to pay for a commodity. The Pricing Engine 404 considers these trends in determining an appropriate price for the commodity.

Regarding economic trends, global finance can affect sales to American consumers. For example, if the economy in a particular country is down, small businesses may be unable to survive. This can result in a high demand for certain commodities that small businesses sell. The Pricing Engine 404 considers these trends in determining an appropriate price for the commodity.

Regarding news and events, local news and events can affect how consumers make purchases. For example, if a generally festive event occurs in a particular region (e.g., a local sporting team wins a championship), consumers from that region are likely to celebrate. Those consumers may want to purchase food for parties. Because demand for such commodities is relatively high, the Pricing Engine 404 can determine that the price for these commodities should be higher than usual.

Regarding regional and sub-regional trends, global events can affect how consumers make purchases on a global scale in a similar way as local news and events.

Regarding global trends, current events can affect commodity pricing. For example, during times of conflict in a particular area, some commodities may not be sold in that area. Alternatively, the demand for commodities in other areas can be affected. The Pricing Engine 404 considers these trends in determining an appropriate price for commodities.

Regarding commodity pricing, price trends allow for historical data to predict a commodity's value in the future. For example, if a particular commodity is steadily increasing in value due to low supply, the Pricing Engine 404 can use this information to determine an appropriate price for the commodity.

Regarding commodity quality, while some commodities are subjective in quality, others are not. For example, in the context of food, the quality of the food has an impact on what a consumer is willing to pay for it. As such, the Pricing Engine 404 can consider the quality of the food (e.g., as specified by the retailer) to determine an appropriate price for the food.

Regarding nature dependent analysis, natural disasters can affect the demand for a commodity. For example, a drought may affect the amount of produce that is available in a particular region, resulting in higher demand for the produce. As such, the Pricing Engine 404 can determine that the price for the produce should be higher than usual.

Regarding specific sales by business, the retailer can specify a custom sale price for a particular commodity. The Pricing Engine 404 can use this information to determine an appropriate price for the commodity.

Regarding calendar-based holidays/events, certain holidays and events are associated with particular purchasing trends, resulting in the demand for certain commodities rising. The Pricing Engine 404 can consider these trends to determine an appropriate price for the commodity.

Regarding religious trends, religious holidays are associated with particular purchasing trends, resulting in the demand for certain commodities rising. The Pricing Engine 404 can consider these trends to determine an appropriate price for the commodity.

Regarding cultural trends, certain cultures follow specific trends and customers leading to a rise in particular commodities, resulting in the demand for those commodities rising. The Pricing Engine 404 can consider these trends to determine an appropriate price for the commodity.

Regarding commodity demand, the demand for a commodity is typically related to the price that a consumer is willing to pay for the commodity. The Pricing Engine 404 can consider the demand for a commodity to determine an appropriate price for the commodity.

Regarding inventory, a retailer can specify the quantity of a commodity that is available and define pricing rules that are based on the quantity. The Pricing Engine 404 can consider the available quantity and the defined rules to determine an appropriate price for the commodity.

Regarding custom business-specified validation and custom business-specified rules, a retailer can specify custom rules related to a commodity, and the Pricing Engine 404 can consider these rules to determine an appropriate price for the commodity.

Regarding commodity pricing and purchase history, information related to how much consumers typically pay for a particular commodity at a particular time can be considered by the Pricing Engine 404 and used to determine an appropriate price for the commodity.

Regarding sentiment analysis, in some cases, the media can have a great effect on how consumers view the value of a commodity. For example, if the media publicizes negative or positive information about a particular commodity, a consumer's desire to purchase the commodity can be decreased or increased. This, in turn, affects what the consumer is willing to pay for the commodity. The Pricing Engine 404 can consider this information to determine an appropriate price for the commodity.

The Pricing Engine 404 continuously monitors the discounted price of the commodity included in the offer for sale in light of the data from the various sources to determine whether the price continues to be reasonable. For example, as time passes, the commodity diminishes in value. In some cases, the commodity diminishes in value until it is no longer sellable or useful. The Pricing Engine 404 takes this into account and can continuously update the discounted price of the commodity accordingly. For example, if a container of yogurt has an expiration date in ten days, its value at five days from the expiration date can be viewed as lower than its value five days prior. The value of the container of yogurt can continue to depreciate until the date of expiration occurs, at which time the value may be zero. The Pricing Engine 404 may be utilized to automatically update the sale price based on a predetermined depreciation scale as recommended by the Pricing Engine 404. In some implementations, the Pricing Engine 404 may be customized by the retailer to a custom depreciation scale over time. Such customization can be defined in the retailer preferences. In some implementations, the Pricing Engine 404 may be deactivated entirely and a non-depreciating sale price may be pushed to the Matching Engine.

In some implementations, the retailer or the Pricing Engine 404 may reverse the depreciation scale. As such, the price of the commodity may appreciate as the date of expiration approaches. For example, if an item such as a new yet-to-be-released phone is being sold at a pre-release price, which the retailer elects to sell a set volume of at a lower-than-retail price, the price of the item may increase on a set scale and approach the retail price on a particular date, as defined in the retailer preferences.

The retailer has control over some aspects of the Pricing Engine 404. As described above, the offer for sale can include retailer preferences. In some implementations, the retailer preferences include information related to the settings of the Pricing Engine 404. The retailer preferences can override some operations of the Pricing Engine 404. For example, the retailer preferences can specify that the Pricing Engine 404 cannot price the commodity below a particular amount. The retailer preferences can also specify the rate of depreciation of the commodity.

As the discounted price of the commodity changes, the Matching Engine may identify additional matches between corresponding offer for sale and purchase preferences of consumers.

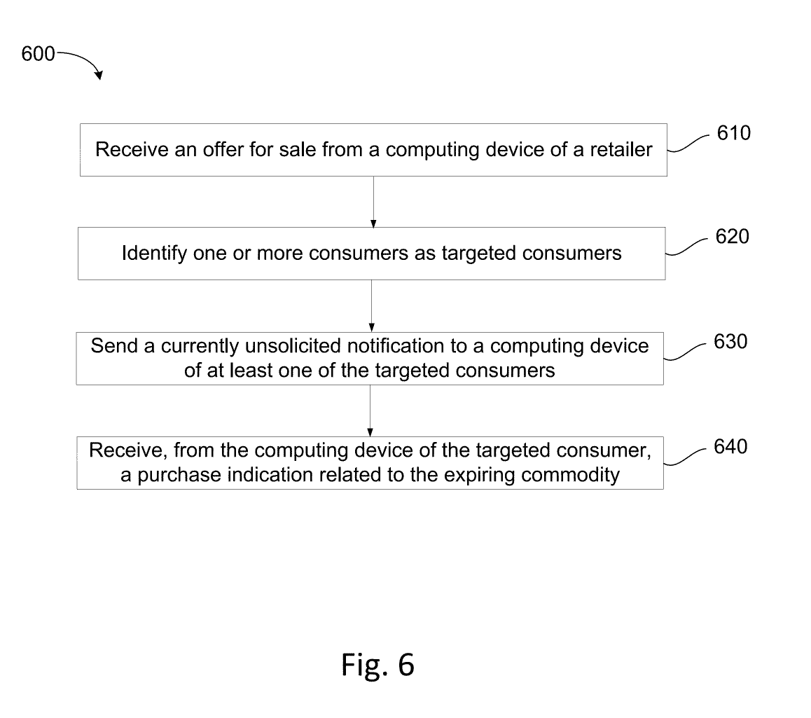

FIG. 6 shows an example process 600 for purchasing an expiring commodity. The process 600 can be performed, e.g., by the system 100 for facilitating a sale of expiring commodities as shown in FIG. 1. In step 610, the process receives an offer for sale from a computing device of a retailer. For example, the offer for sale 106 can be received on the server 120 from the computing device 114 of the retailer 104, as shown in FIG. 1. The offer for sale can include a description of an expiring commodity and a discounted price of the expiring commodity. In step 620, the process identifies one or more consumers as targeted consumers. For example, the one or more consumers can be identified as targeted consumers, e.g., targeted consumer 122, by the server 120. The server 120 can identify the one or more consumers as targeted consumers by comparing the offer for sale with purchase preferences previously provided by consumers, e.g., purchase preferences 202, as shown in FIG. 2. In step 630, the process sends a currently unsolicited notification to a computing device of at least one of the targeted consumers. For example, the currently unsolicited notification can be sent from the server 120 to the computing device 114 of the targeted consumer 122. The currently unsolicited notification can include information related to the offer for sale 106. The currently unsolicited notification can be a push notification sent using push technology. In step 640, the process receives, from the computing device of the targeted consumer, a purchase indication related to the expiring commodity. For example, the purchase indication can be received on the server 120 from the computing device 114 of the targeted consumer 122.

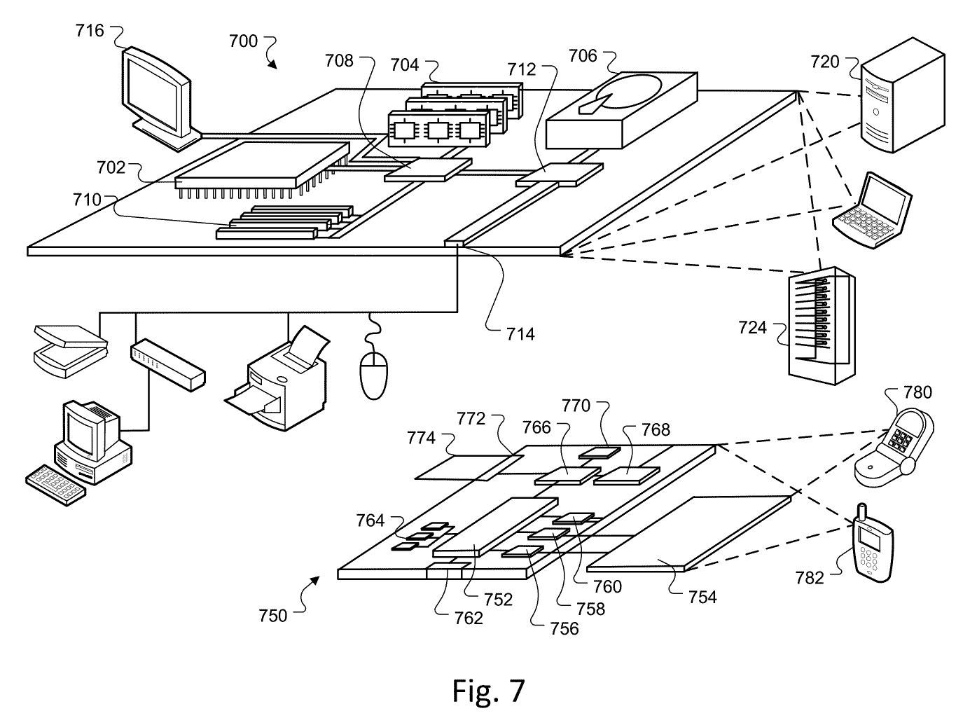

FIG. 7 shows an example of a computing device 700 and a mobile computing device 750 that can be used to implement the techniques described in this disclosure. For example, the computing device 700 and/or the mobile computing device 750 could be the computing device 114 shown in FIGS. 1 and 2. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in an obfuscated or encrypted manner.

The memory may include, for example, flash memory and/or NVRAM memory (non-volatile random access memory), as discussed below. In some implementations, instructions are stored in an information carrier. The instructions, when executed by one or more processing devices (for example, processor 752), can perform one or more methods, such as those described above. The instructions can also be stored by one or more storage devices, such as one or more computer or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, GPRS (General Packet Radio Service), or WAN (Wide Area Network), among others. Such communication may occur, for example, through the transceiver 768 using a radio-frequency. In addition, short-range communication may occur, such as using a Bluetooth, WiFi, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While certain implementations have been described, other implementations are possible.

While we described expiring commodities in the context of food, expiring commodities exist in a number of other contexts.

While we described the computing device as including a transceiver that allows the computer device to communicate wirelessly with a network, in some implementations, the computing device can communicate with a network through a wired connection. For example, the computing device can be hardwired to the Internet through a router and/or a modem.

In some implementations, the expiring commodity is a travel ticket. For example, airline tickets, train tickets, ferry tickets, and bus tickets are no longer useful after the trip occurs. As such, as the departure date approaches, a travel business may choose to reduce the price of tickets to motivate consumers to purchase them. Otherwise, the travel business takes the risk of the seat being unused.

In some implementations, the expiring commodity is a room of an establishment that provides lodging, such as a hotel. For example, in some cases, hotels are not completely booked for a given night. A hotel does not receive any payment for unused rooms. As the day progresses, a hotel may choose to reduce the price of a room to motivate guests to rent the room. Otherwise, the hotel takes the risk of the room being unused.

In some implementations, the expiring commodity is an entertainment ticket. For example, theater tickets, concert tickets, sporting event tickets, and movie tickets are no longer useful after the entertainment event occurs. As such, as the date of the event approaches, an entertainment business may choose to reduce the price of tickets to motivate consumers to purchase them. In some implementations, the entertainment business may allow a consumer to “line skip” upon purchasing a ticket.

In some implementations, the expiring commodity is a dining reservation. For example, a reservation at a popular restaurant may be available for a particular time. It may be extremely difficult to get a reservation at the particular restaurant. As such, as the available time approaches, the restaurant may offer the reservation to consumers for a fixed premium cost.

In some implementations, the expiring commodity is a high demand commodity. In other words, consumer may be willing to pay face value or more than the face value for the expiring commodity. For example, in the context of movie tickets, tickets for a movie premiere may be in high demand. A movie theater can offer to sell tickets to the premiere for face value plus a premium handling fee for access to the high demand event.

In some implementations, high demand commodities that have a limited quantity are randomly offered to consumers who have defined purchase preferences that match the offer for sale. In some implementations, some consumers have higher prioritization than others.

In some implementations, the expiring commodity is a retail item. For example, clothing prior to a change of seasons, electronics prior to a new generation being released, and vehicles prior to a model change have diminished value from a consumer's point of view. A typical consumer may prefer to wait to purchase the newer version of the particular item. As such, as the weather changes or as the release date approaches, a business may choose to reduce the price of the retail items to motivate customers to purchase them.

In some implementations, rather than the Matching Engine comparing offers for sale to purchase preferences in order to identify targeted consumers, the Matching Engine uses information gathered by a troll algorithm and compares the gathered information to purchase preferences of consumers. The troll algorithm can scan information on retailers' websites to obtain information related to various commodities. In some implementations, if the retailer associated with a particular website is running a promotion, the troll algorithm considers the promotion to determine commodity pricing. The Matching Engine can use the commodity pricing information from the troll algorithm to identify targeted consumers.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the invention have been described. Other implementations are within the scope of the following claims. For example, the actions recited in the claims can be performed in a different order and still achieve desirable results.

What is claimed is:

1. A computer-implemented method comprising:
receiving, on a server, an offer for sale from a computing device related to a retailer, the offer for sale including a description of an expiring commodity and a discounted price of the expiring commodity;
identifying, by the server, one or more consumers as targeted consumers by comparing the offer for sale with purchase preferences previously provided by consumers;
sending, from the server, a currently unsolicited notification to a computing device related to at least one of the targeted consumers, the currently unsolicited notification including information related to the offer for sale; and
receiving, on the server, from the computing device related to the targeted consumer, a purchase indication related to the expiring commodity.

2. The method of claim 1, wherein at least one of the computing device related to the retailer and the computing device related to the targeted consumer is located remotely from the server.

3. The method of claim 1, wherein the offer for sale includes a regular price of the expiring commodity.

4. The method of claim 1, wherein each of the purchase preferences includes an expiring commodity and a value threshold.

5. The method of claim 4, wherein comparing the offer for sale with purchase preferences of the one or more consumers includes determining whether:
the expiring commodity of the offer for sale matches the expiring commodity of each of the purchase preferences; and
the discounted price of the offer for sale satisfies the value threshold of each of the purchase preferences.

6. The method of claim 1, wherein one or more of the purchase preferences includes a particular retailer.

7. The method of claim 6, wherein comparing the offer for sale with purchase preferences of the one or more consumers includes determining whether the retailer associated with the offer for sale matches the particular retailer of the one or more purchase preferences.

8. The method of claim 1, wherein the currently unsolicited notification includes one or more of a name of the retailer, an address of the retailer, the description of the expiring commodity, the discounted price of the expiring commodity, a regular price of the expiring commodity, and a quantity field.

9. The method of claim 1, wherein the currently unsolicited notification includes a purchase code related to a consumer preference.

10. The method of claim 1, wherein the currently unsolicited notification includes a countdown timer that represents a time limit for the targeted customer to send the purchase indication.

11. The method of claim 10, wherein the countdown timer can be temporarily frozen one or more times.

12. The method of claim 11, wherein a credit is provided in order to temporarily freeze the countdown timer.

13. The method of claim 1, wherein the purchase indication is provided by a message from the targeted consumer.

14. The method of claim 1, further comprising updating the discounted price of the expiring commodity.

15. The method of claim 14, wherein the discounted price of the expiring commodity is updated based on an expiration date of the expiring commodity.

16. The method of claim 1, wherein the expiring commodity is edible.

17. The method of claim 1, wherein the expiring commodity is a material item.

18. The method of claim 17, wherein the expiring commodity is a piece of clothing, an electronic item, or a vehicle.

19. The method of claim 1, wherein the expiring commodity is a non-edible, non-material item.

20. The method of claim 19, wherein the expiring commodity is a virtual commodity.

21. The method of claim 20, wherein the virtual commodity is software.

22. The method of claim 1, wherein the expiring commodity is a location that provides lodging.

23. The method of claim 22, wherein the location that provides lodging is a hotel MOM.

24. The method of claim 1, wherein the expiring commodity is a ticket.

25. The method of claim 24, wherein the ticket is a travel ticket.

26. The method of claim 25, wherein the travel ticket is an airline ticket, a train ticket, a ferry ticket, or a bus ticket.

27. The method of claim 24, wherein the ticket is an entertainment event ticket.

28. The method of claim 27, wherein the entertainment event ticket is a theater ticket, a concert ticket, a sporting even ticket, or a movie ticket.

29. The method of claim 1, wherein the expiring commodity is a reservation for food consumption or entertainment.

30. The method of claim 29, wherein the reservation is a dining reservation.

31. The method of claim 1, wherein the currently unsolicited notification is a push notification.

32. The method of claim 1, wherein at least one of the computing device related to the retailer and the computing device related to the targeted consumer is a smartphone.

33. The method of claim 1, wherein the currently unsolicited notification is only sent to computing devices related to targeted consumers who are specified in the offer for sale.

34. The method of claim 1, wherein the currently unsolicited notification is only sent to computing devices related to targeted consumers whose purchase preferences have identified the retailer as an approved retailer.

35. The method of claim 1, wherein the currently unsolicited notification is not sent to computing devices related to targeted consumers whose purchase preferences have identified the retailer as a blocked retailer.

36. The method of claim 1, further comprising:
receiving, on the server, from the computing device related to the retailer, information related to one or more expiring commodities that the retailer has previously sold, has in-stock, or intends to purchase.

37. The method of claim 1, further comprising:
receiving, on the server, from the computing device related to the retailer, information related to past, existing, or prospective customers of the retailer.

38. A system comprising:
a server comprising:
a memory configured to store instructions; and
a processor to execute the instructions to perform a method comprising:
receiving, on the server, an offer for sale from a computing device related to a retailer, the offer for sale including a description of an expiring commodity and a discounted price of the expiring commodity;
identifying, by the server, one or more consumers as targeted consumers by comparing the offer for sale with purchase preferences previously provided by consumers;
sending, from the server, a currently unsolicited notification to a computing device related to at least one of the targeted consumers, the currently unsolicited notification including information related to the offer for sale; and
receiving, on the server, from the computing device related to the targeted consumer, a purchase indication related to the expiring commodity.

39. The system of claim 38, further comprising a matching engine that resides on the server, the matching engine configured to determine whether:
the expiring commodity of the offer for sale matches the expiring commodity of each of the purchase preferences; and
the discounted price of the offer for sale satisfies the value threshold of each of the purchase preferences.

40. The system of claim 38, further comprising a pricing engine that resides on the server, the pricing engine configured to update the discounted price of the expiring commodity.

41. The system of claim 40, wherein the pricing engine considers data related to one or more of foreign exchange market trends, financial market trends, economic trends, news and events, regional and sub-regional trends, global trends, commodity pricing, commodity quality, nature dependent analysis, specific sales by business, calendar based holidays/events, religious trends, cultural trends, commodity demand, inventory, custom business-specified validation, custom business-specified rules, commodity pricing history, commodity purchase history, and sentiment analysis.

42. The system of claim 41, further comprising multiple instances of the pricing engine, wherein the multiple instances of the pricing engine are configured to communicate with each other and share information.

43. The system of claim 42, wherein no two instances of the pricing engine consider an exact same set of data.

44. The system of claim 40, wherein the discounted price of the expiring commodity is updated based on an expiration date of the expiring commodity.

45. A computer program product tangibly embodied in an information carrier and comprising instructions that when executed by a processor perform a method comprising:
receiving, on a server, an offer for sale from a computing device related to a retailer, the offer for sale including a description of an expiring commodity and a discounted price of the expiring commodity;
identifying, by the server, one or more consumers as targeted consumers by comparing the offer for sale with purchase preferences previously provided by consumers;
sending, from the server, a currently unsolicited notification to a computing device related to at least one of the targeted consumers, the currently unsolicited notification including information related to the offer for sale; and
receiving, on the server, from the computing device related to the targeted consumer, a purchase indication related to the expiring commodity.
